(19) United States
(12) Patent Application Publication
(10) Pub. No.: US 2025/0028312 A1
(43) Pub. Date: Jan. 23, 2025

(54) GAS MONITORING DETECTORS HEALTHINESS VALIDATION TOOL UTILIZING ANOMALY DETECTION TECHNIQUE

(71) Applicant: SAUDI ARABIAN OIL COMPANY, Dhahran (SA)

(72) Inventors: Shadi M. HAZMI, Udhailiyah (SA); Tarek D. ABOGHONIEM, Udhailiyah (SA); Mohannad M. SHAHRANI, Udhiliyah (SA); Yahya A. ALI, Udhiliyah (SA)

(73) Assignee: SAUDI ARABIAN OIL COMPANY, Dhahran (SA)

(21) Appl. No.: 18/356,114

(22) Filed: Jul. 20, 2023

(51) Int. Cl. G05B 23/02

(52) U.S. Cl. CPC G05B 23/0254; G05B 23/024

(57) ABSTRACT

A gas monitoring detector healthfulness tracking system including an analyzer operable to apply an artificial intelligence (AI) model to determine a characteristic response trend signature from received preventative maintenance (PM) data and maintenance tracking data, an anomaly detector operable to detect an anomalous field response characteristic of a gas monitoring detector from received PM field data, the anomalous field response characteristic representing a variance from the characteristic response trend signature, a recommender providing a recommendation to 1) replace the gas monitoring detector if the variance exceeds a predetermined value, 2) re-test the gas monitoring detector if the variance does not match and does not exceed the predetermined value, and a report generator for reporting the recommendation of the recommender.

### FIELD OF THE DISCLOSURE

The present disclosure relates generally to preventative maintenance (PM) of gas monitoring detectors deployed in industrial facilities, and, more particularly, to monitoring the healthfulness of such gas monitoring detectors using a predictive AI approach.

### BACKGROUND OF THE DISCLOSURE

Industrial facilities utilize many sensors and detectors to protect the integrity of the their processes and ensure the safety of personnel and physical assets. For instance, in an oil and gas plant, hundreds of gas monitoring detectors of different types may be deployed, to warn of dangerous gas leaks. These detectors require a preventative maintenance (PM) program to ascertain that they are in working order and to replace, repair and calibrate detectors as the need arises.

Conventionally, maintenance consists of testing gas monitoring detectors, at scheduled times, to determine if they meet threshold operational requirements, and repairing or replacing them if they fail. This reactive approach is dissatisfactory because a gas monitoring detector could pass a test but very shortly thereafter fail, and would remain inoperative in the field until the next test cycle. In addition, some gas monitoring detectors could pass the threshold test by a minimal margin, but could degenerate in performance shortly thereafter, and may not be able to properly detect a hazardous situation.

What is needed is a proactive approach to preventative maintenance of equipment such as gas monitoring detectors. Such an approach would remove equipment in response to predicted failure, even if the equipment were able to meet threshold operating requirements and pass preventative maintenance tests, averting future dangerous situations, for example caused by undetected gas leaks.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a gas monitoring detector healthfulness tracking system including an analyzer operable to apply an artificial intelligence (AI) model to determine a characteristic response trend signature from received preventative maintenance (PM) data and maintenance tracking data, an anomaly detector operable to detect an anomalous field response characteristic of a gas monitoring detector from received PM field data, the anomalous field response characteristic representing a variance from the characteristic response trend signature, a recommender providing a recommendation to 1) replace the gas monitoring detector if the variance exceeds a predetermined value, 2) re-test the gas monitoring detector if the variance does not match and does not exceed the predetermined value, and a report generator for reporting the recommendation of the recommender.

In another embodiment, a method for monitoring the healthfulness of gas monitoring detectors includes applying, by a processor, an artificial intelligence (AI) model to determine a characteristic response trend signature from received preventative maintenance (PM) data and, optionally, maintenance tracking data, detecting, by the processor, an anomalous field response characteristic of a gas monitoring detector from received PM field data, the anomalous field response characteristic representing a variance from the characteristic response trend signature, recommending, by the processor, 1) replacement of the gas monitoring detector if the variance exceeds a predetermined value, 2) re-testing of the gas monitoring detector if the variance does not match and does not exceed the predetermined value, and reporting, by the processor, the recommendation.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a block diagram of a gas monitoring network deployed in an industrial facility, such as an oil and gas plant, in accordance with certain embodiments.

FIG. 2 is a block diagram of a gas monitoring detector healthfulness tracking system 110 in accordance with certain embodiments.

FIGS. 3A and 3B respectively show an expected characteristic response trend signature and anomalous field response characteristics in one example in accordance with certain embodiments.

FIG. 4 is flow diagram of a method for monitoring the healthfulness of gas monitoring detectors in accordance with certain embodiments.

FIG. 5 is a block diagram of a computer system that may be used to implement one or more of the systems or methods described herein in accordance with certain embodiments.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to preventative maintenance (PM) of gas monitoring detectors deployed in industrial facilities, and, more particularly, to monitoring the healthfulness of such gas monitoring detectors using a predictive AI approach.

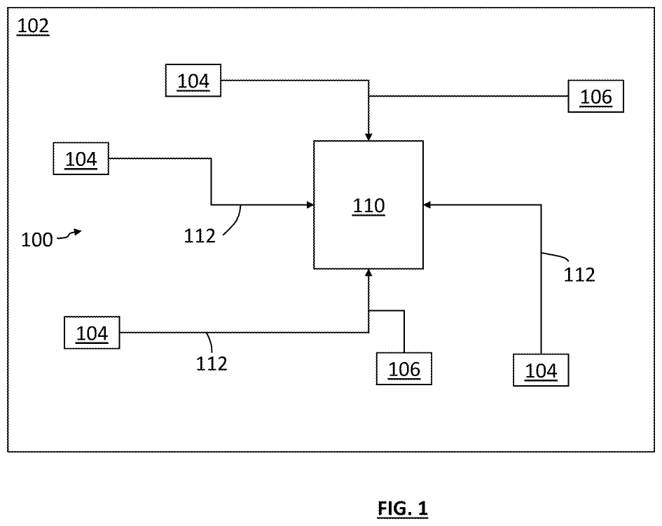

FIG. 1 is a block diagram of a gas monitoring network 100 deployed in an industrial facility 102, such as an oil and gas plant, in accordance with certain embodiments. Gas monitoring network 100 includes one or more gas monitoring detectors 104 of a first type, and one or more gas monitoring detectors 106 of a second type. Each type of gas monitoring detector may be dedicated to the detection of a specific gas; or both types may be operable to detect the same gas-oxygen for instance. Although only two types are discussed, more or less than two types of gas monitoring detectors are possible.

Gas monitoring detectors 104, 106 are communicatively coupled to a healthfulness tracking system 110 by way of wired or wireless communication channels 112. The healthfulness tracking system 110 may be part of a control system (not shown) of the facility 102, or separate therefrom and in communication therewith.

The communication channels 112 serve to convey information and data indicative of the operation of the gas monitoring detectors 104, 106 to the healthfulness tracking system 110. While represented by one-headed arrows, the channels 112 can operate bi-directionally, whereby signals and data such as commands can be conveyed from the healthfulness tracking system 110 to the gas monitoring detectors 104. 106, for example to initiate a testing routine of a selected gas monitoring detector, gather resultant data, activate a data dump therefrom, and the like.

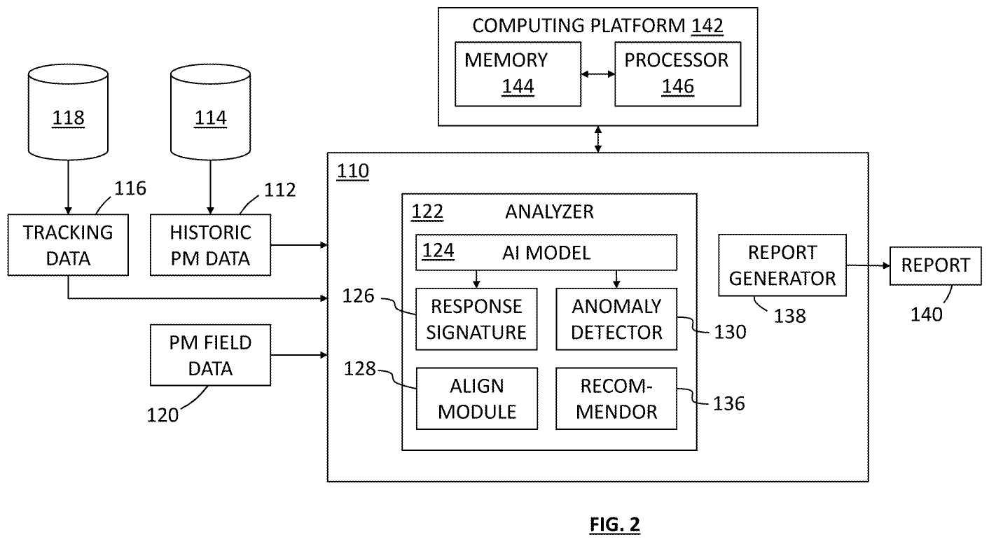

FIG. 2 is a block diagram of a gas monitoring detector healthfulness tracking system 110 in accordance with certain embodiments. Healthfulness tracking system 110 is operable to receive historic preventative maintenance (PM) data 112 from a control system historian database 114, and, optionally, other PM tracking data 116, for example from an SAP system database 118. In addition, healthfulness tracking system 110 is operable to receive PM field data 120 from a latest or current PM that is conducted. The PM field data 120 contains field response characteristic for each gas monitoring detector.

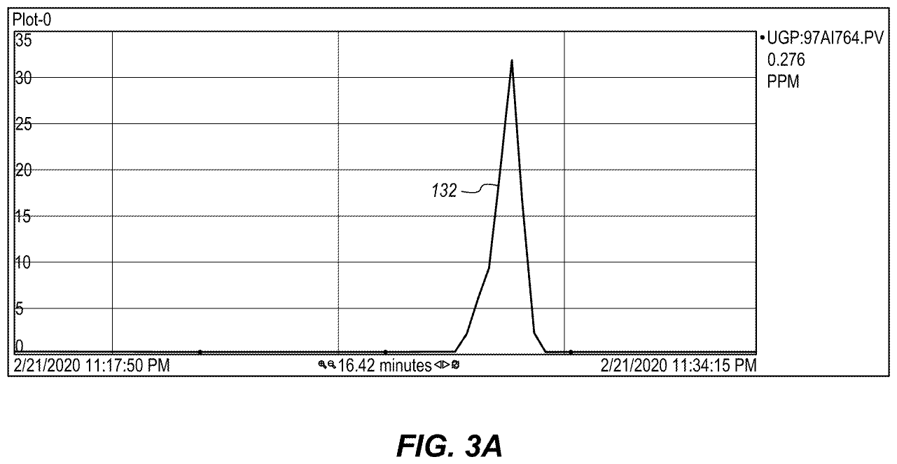

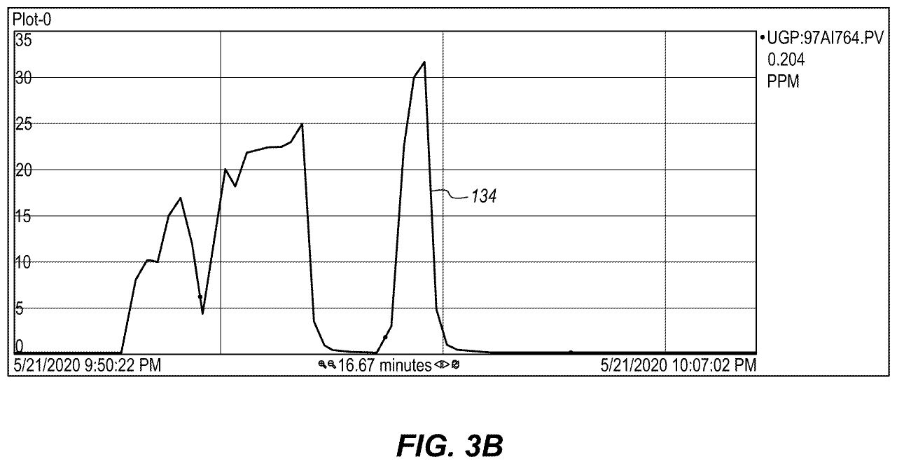

Healthfulness tracking system 110 includes an analyzer 122 that uses an AI (artificial intelligence) model 124 to determine a characteristic response trend signature 126 for each type of gas monitoring detector 104, 106 from the received historic PM data (112) and PM tracking data (116), and to determine the presence of anomalies in received field response characteristics in the PM field data 120 representative of PM tests conducted using the gas monitoring detectors. In certain embodiments, analyzer 122 can include an alignment module 128 that ascertains that the PM field data 120 is obtained from a PM test that is sufficiently faithful to prior tests and protocols, such that a meaningful anomaly determination can be made. The field response characteristics in the PM field data 120 is benchmarked against characteristic response trend signatures 126 for each type of gas monitoring detector 104. 106 by anomaly detector 130, which is operable to determine anomalies in the field response characteristics. AI model 124 utilizes anomaly detection techniques to examine the data points for conducted PM for gas detectors and report any deviation from the characteristic response trend signature. Detected anomalous field response characteristics of the gas monitoring detectors 104, 106 from the PM field data 120 are used to indicate potential performance degradation of the gas monitoring detectors under consideration. FIGS. 3A and 3B respectively show an expected characteristic response trend signature 132 and anomalous field response characteristics 134 in one example. Anomaly detector 130 is tuned to detect this variance between the two characteristics and provide an output indicative thereof. Anomaly detection is tuned with the dataset patterns from the characteristic response trend signature. Any deviation from the characteristic response is reported as degradation of the gas detector. Utilizing anomaly detection and machine learning, the model is operable to tune the level of acceptable deviation from characteristic response based on several test results of the same gas detector as well as the degradation percentage over time.

In certain embodiments, an exact match between the characteristic response trend signature and the acquired field response characteristics from the PM field data 120 may not be required, and an acceptable variation may be permitted. An output of anomaly detector 130 may be provided to recommender 136 to make such a determination. Specifically, in one example, recommender 136 can recommend that a particular gas monitoring detector 104, 106 under test be re-tested if a variation between the characteristic response trend signature and the field response characteristics exists but does not exceed about 20%, or some other user-selected value. If this occurs multiple times, or if the variation does exceed about 20%, then replacement of the gas monitoring detector may be recommended instead. It will be appreciated that 20% deviation from characteristic response may be the initial tuning setting; however, AI model 124 may change this setting based on historical failures.

The recommendations are provided to a report generator 138, which can output the findings and recommendations of healthfulness tracking system 110 in the form of a report 140. The report can be in the form of alerts or other bulletins to various stakeholders informing them of the findings and recommending remedial measures. It can for instance include a list of all gas monitoring detectors 104, 106 conducted PM not matching with the characteristic response trend signature of relevant detector type; a list of all gas monitoring detectors conducted PM not matching with SAP system or any other tracking system; and/or alerts to an operator and maintenance personnel about potential degradation in the gas monitoring detectors. Receipt of tracking data 116 and historic PM data 112 allows healthfulness tracking system 110 to ensure that all conducted PM listed in the tracking system are actually implemented as per control system historical data. List of all gas monitoring detectors conducted PM not matching with SAP system or any other tracking system will be issued as output in the report 140.

In some examples, one or more aspects of the healthfulness tracking system 110, such as analyzer 122 and report generator 138, can be implemented (e.g., as machine readable instructions) on a computing platform 142. The computing platform 142 can include one or more computing devices selected from, for example, a desktop computer, a server, a controller, a blade, a mobile phone, a tablet, a laptop, a personal digital assistant (PDA), and the like. The computing platform 142 can include a memory 144 and a processor 146. By way of example, the memory 144 can be implemented, for example, as a non-transitory computer storage medium, such as volatile memory (e.g., random access memory), non-volatile memory (e.g., a hard disk drive, a solid-state drive, a flash memory, or the like), or a combination thereof. The processor 146 can be implemented, for example, as one or more processor cores.

The memory 144 can store machine-readable instructions that can be retrieved and executed by the processor 146. Each of the processor 146 and the memory 144 can be implemented on a similar or a different computing platform. The computing platform 142 can be implemented in a cloud computing environment (for example, as disclosed herein) and thus on a cloud infrastructure. In such a situation, features of the computing platform 142 can be representative of a single instance of hardware or multiple instances of hardware executing across the multiple of instances (e.g., distributed) of hardware (e.g., computers, routers, memory, processors, or a combination thereof). Alternatively, the computing platform 142 can be implemented on a single dedicated server or workstation.

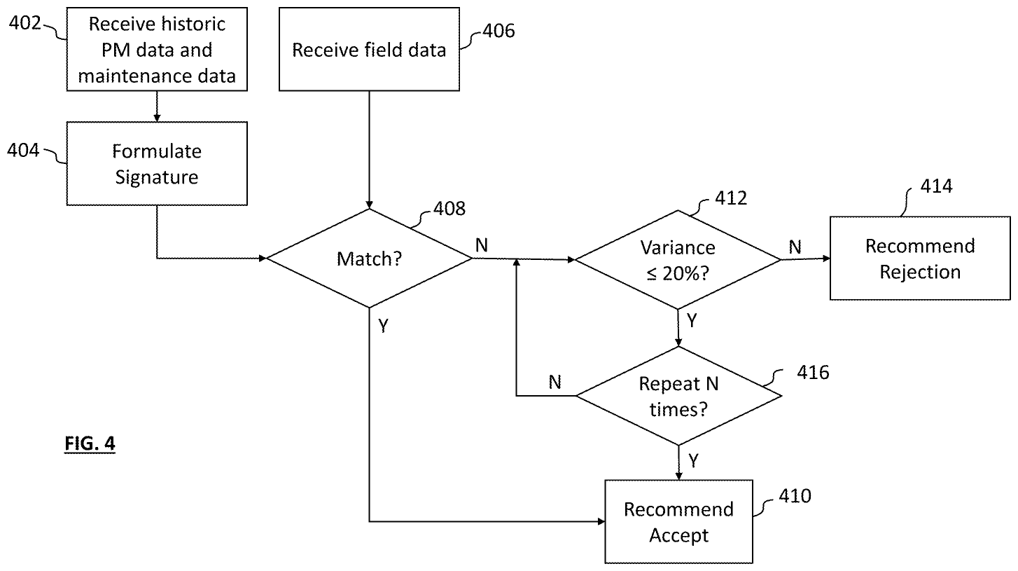

In view of the structural and functional features described above, example methods will be better appreciated with reference to FIG. 4. While, for purposes of simplicity of explanation, the example methods of FIG. 4 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

FIG. 4 is flow diagram of a method 400 for monitoring the healthfulness of gas monitoring detectors in accordance with certain embodiments. Method 400 includes, at 402, receipt of historic PM data and possibly maintenance data by a healthfulness tracking system such as system 110 above. At 404, an AI model is used, for example by an analyzer such as analyzer 122 (FIG. 2), to formulate characteristic response trend signature for each type of gas monitoring detector from the received historic PM data and maintenance data. At 406, PM field data including field response characteristics of gas monitoring detectors is received. At 408, a determination is made, for example by anomaly detector 130 (FIG. 2), whether an anomaly exists or a substantial match exists between a detector characteristic response trend signature and the acquired field response characteristic from the PM field data. If a substantial match exists, a recommendation that the gas monitoring detector is in a healthful state is made at 410, for example by recommender 136 (FIG. 2). If no substantial match, then at 412, a determination is made whether a variance between a characteristic response trend signature and the acquired field response characteristic from the PM field data is less than a predetermined amount, such as 20%. If it is not less than 20%, then a replacement recommendation is generated at 414. If it is less than 20%, a determination is made at 416 whether a predetermined number of variance re-tests has been conducted, after which a recommendation to accept can be made at 410. As mentioned above, 20% deviation from characteristic response may be the initial tuning setting; however, AI model 124 may change this setting based on historical failures.

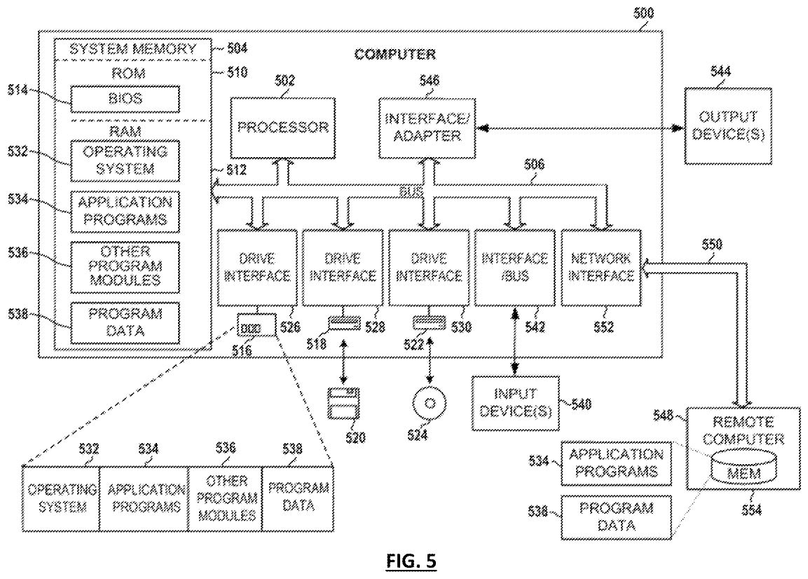

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 5. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 5 illustrates one example of a computer system 500 that can be employed to execute one or more embodiments of the present disclosure. Computer system 500 can be implemented on one or more general purpose networked computer systems, embedded computer systems, routers, switches, server devices, client devices, various intermediate devices/nodes or standalone computer systems. Additionally, computer system 500 can be implemented on various mobile clients such as, for example, a personal digital assistant (PDA), laptop computer, pager, and the like, provided it includes sufficient processing capabilities.

Computer system 500 includes processing unit 502, system memory 504, and system bus 506 that couples various system components, including the system memory 504, to processing unit 502. System memory 504 can include volatile (e.g. RAM, DRAM, SDRAM, Double Data Rate (DDR) RAM, etc.) and non-volatile (e.g. Flash. NAND, etc.) memory. Dual microprocessors and other multi-processor architectures also can be used as processing unit 502. System bus 506 may be any of several types of bus structure including a memory bus or memory controller, a peripheral bus, and a local bus using any of a variety of bus architectures. System memory 504 includes read only memory (ROM) 510 and random access memory (RAM) 512. A basic input/output system (BIOS) 514 can reside in ROM 510 containing the basic routines that help to transfer information among elements within computer system 500.

Computer system 500 can include a hard disk drive 516. magnetic disk drive 518, e.g., to read from or write to removable disk 520, and an optical disk drive 522, e.g., for reading CD-ROM disk 524 or to read from or write to other optical media. Hard disk drive 516, magnetic disk drive 518, and optical disk drive 522 are connected to system bus 506 by a hard disk drive interface 526. a magnetic disk drive interface 528, and an optical drive interface 530, respectively. The drives and associated computer-readable media provide nonvolatile storage of data, data structures, and computer-executable instructions for computer system 500. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 510, including operating system 532, one or more application programs 534, other program modules 536, and program data 538. In some examples, the application programs 534 can include analyzer 122, anomaly detector 130, alignment module 128, recommender 136, and report generator 138, and the program data 538 can include the received maintenance data 116, historic PM data 112, and PM field data 120 for instance. The application programs 534 and program data 538 can include functions and methods programmed to monitor the healthfulness of gas monitoring detectors, such as shown and described herein.

A user may enter commands and information into computer system 500 through one or more input devices 540, such as a pointing device (e.g., a mouse, touch screen), keyboard, microphone, joystick, game pad, scanner, and the like. For instance, the user can employ input device 540 to edit or modify the user-selected variation value (i.e., the 20% above), the number of iterations in step 416 (i.e., the value of N), and so on. These and other input devices 540 are often connected to processing unit 502 through a corresponding port interface 542 that is coupled to the system bus, but may be connected by other interfaces, such as a parallel port, serial port, or universal serial bus (USB). One or more output devices 544 (e.g., display, a monitor, printer, projector, or other type of displaying device) is also connected to system bus 506 via interface 546, such as a video adapter.

Computer system 500 may operate in a networked environment using logical connections to one or more remote computers, such as remote computer 548. Remote computer 548 may be a workstation, computer system, router, peer device, or other common network node, and typically includes many or all the elements described relative to computer system 500. The logical connections, schematically indicated at 550, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 500 can be connected to the local network through a network interface or adapter 552. When used in a WAN networking environment, computer system 500 can include a modem, or can be connected to a communications server on the LAN. The modem, which may be internal or external, can be connected to system bus 506 via an appropriate port interface. In a networked environment, application programs 534 or program data 538 depicted relative to computer system 500, or portions thereof, may be stored in a remote memory storage device 554.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A gas monitoring detector healthfulness tracking system comprising:
an analyzer operable to apply an artificial intelligence (AI) model to determine a characteristic response trend signature from received preventative maintenance (PM) data and maintenance tracking data;
an anomaly detector operable to detect an anomalous field response characteristic of a gas monitoring detector from received PM field data, the anomalous field response characteristic representing a variance from the characteristic response trend signature;
a recommender providing a recommendation to 1) replace the gas monitoring detector if the variance exceeds a predetermined value, 2) re-test the gas monitoring detector if the variance does not match and does not exceed the predetermined value; and
a report generator for reporting the recommendation of the recommender.

2. The gas monitoring detector healthfulness tracking system of claim 1, further comprising an alignment module operable to ascertain that the PM field data is obtained from a PM test that is sufficiently faithful to prior tests and protocols.

3. The gas monitoring detector healthfulness tracking system of claim 1, wherein variance from the characteristic response trend signature is reported as degradation of a gas detector.

4. The gas monitoring detector healthfulness tracking system of claim 1, wherein the AI model is operable to tune a level of acceptable variance from the characteristic response trend signature based on several test results of the same gas detector.

5. The gas monitoring detector healthfulness tracking system of claim 2, wherein the AI model is operable to tune a level of acceptable variance from the characteristic response trend signature further based on degradation percentage over time.

6. The gas monitoring detector healthfulness tracking system of claim 1, wherein the predetermined value is about 20%.

7. The gas monitoring detector healthfulness tracking system of claim 1, wherein the predetermined value is changeable by the AI model.

8. The gas monitoring detector healthfulness tracking system of claim 7, wherein the predetermined value is changeable by the AI model based on historical failures.

9. A method for monitoring the healthfulness of gas monitoring detectors, the method comprising:
applying, by a processor, an artificial intelligence (AI) model to determine a characteristic response trend signature from received preventative maintenance (PM) data and, optionally, maintenance tracking data;
detecting, by the processor, an anomalous field response characteristic of a gas monitoring detector from received PM field data, the anomalous field response characteristic representing a variance from the characteristic response trend signature;
recommending, by the processor, 1) replacement of the gas monitoring detector if the variance exceeds a predetermined value, 2) re-testing of the gas monitoring detector if the variance does not match and does not exceed the predetermined value; and
reporting, by the processor, the recommendation.

10. The method of claim 9, further comprising ascertaining that the PM field data is obtained from a PM test that is sufficiently faithful to prior tests and protocols.

11. The method of claim 9, wherein variance from the characteristic response trend signature is reported as degradation of a gas detector.

12. The method of claim 9, wherein the AI model is operable to tune a level of acceptable variance from the characteristic response trend signature based on several test results of the same gas detector.

13. The method of claim 12, wherein the AI model is operable to tune a level of acceptable variance from the characteristic response trend signature further based on degradation percentage over time.

14. The method of claim 9, wherein the predetermined value is about 20%.

15. The method of claim 9, wherein the predetermined value is changeable by the AI model.

16. The method of claim 15, wherein the predetermined value is changeable by the AI model based on historical failures.
